(19) United States
(12) Patent Application Publication
(10) Pub. No.: US 2009/0225692 A1
(43) Pub. Date: Sep. 10, 2009

(54) APPARATUS AND METHOD FOR COMMUNICATING MULTICAST AND BROADCAST SERVICE MAP MESSAGE IN A BROADBAND WIRELESS COMMUNICATION SYSTEM

(75) Inventor: Yeong-Moon SON, Yongin-si (KR)

Correspondence Address: Jefferson IP Law, LLP, 1730 M Street, NW, Suite 807, Washington, DC, 20036, US

(73) Assignee: Samsung Electronics Co. Ltd., Suwon-si (KR)

(21) Appl. No.: 12/399,199

(22) Filed: Mar. 6, 2009

(30) Foreign Application Priority Data
Mar. 7, 2008 (KR) 10-2008-0021351

(51) Int. Cl. H04H 20/71

(52) U.S. Cl. 370/312

(57) ABSTRACT

An apparatus and method for communicating a Multicast and Broadcast Service (MBS) MAP message in a broadband wireless communication system are provided. An operation method of a Base Station (BS) includes periodically generating an MBS MAP message that includes burst allocation information on at least one MBS channel having a different transmission period, and transmitting the generated MBS MAP message in a corresponding frame based on a set period.

### PRIORITY

This application claims the benefit under 35 U.S.C. §119(a) of a Korean patent application filed in the Korean Intellectual Property Office on Mar, 7, 2008 and assigned Serial No. 10-2008-0021351, the entire disclosure of which is hereby incorporated by reference.

### BACKGROUND OF THE INVENTION

1. Field of the Invention

The present invention relates to an apparatus and method for a broadcast service in a wireless communication system. More particularly, the present invention relates to an apparatus and method for communicating a Multicast and Broadcast Service (MBS) MAP message in a broadband wireless communication system.

2. Description of the Related Art

In a 4^{th} Generation (4G) communication system, which is a next generation communication system, research is being conducted to provide users with services having various Qualities-of-Service (QoSs) at a data rate of about 100 Mbps. In particular, a study of the 4G communication system is being made to support high-speed services as a way to guarantee mobility and QoS for a Broadband Wireless Access (BWA) communication system such as wireless Local Area Network (LAN) system and wireless Metropolitan Area Network (MAN) system. An exemplary BWA communication system is a communication system based on the Institute of Electrical and Electronics Engineers (IEEE) 802.16 standard.

The IEEE 802.16 broadband wireless communication system provides services such as Internet, Voice over Internet Protocol (VoIP), non-real-time streaming services, etc. Multicast and Broadcast Service (MBS), a real-time broadcast service, is attracting attention as a new service. In particular, the MBS allows a plurality of Base Stations (BSs) to transmit a broadcast data burst following the same coding scheme through the same frequency and time resource, thereby making it possible for a Mobile Station (MS) located at a cell edge to obtain a macro diversity effect through Radio Frequency (RF) combining.

FIG. 1 is a diagram illustrating a structure of a DownLink (DL) frame for providing MBS in a conventional broadband wireless communication system.

As illustrated in FIG. 1, in order to support macro diversity, a plurality of BSs define a partial region of a frame as an MBS region 150, and transmit MBS data bursts 111, 113, and 115 in the MBS region 150. A position of the MBS region 150 is forwarded through a DL MAP message 103. The DL MAP message 103 includes an MBS MAP_Information Element (MBS MAP_IE) 105. The MBS_MAP_IE 105 includes position information in an MBS MAP message 107 that includes allocation information on the MBS data bursts 111, 113, and 115. Thus, an MS determines a position of the MBS MAP message 107 through the DL MAP message 103 and determines the position of the MBS region 150 and position and coding information in each of the MBS data bursts 111, 113, and 115 within the MBS region 150 through the MBS MAP message 107, thereby being able to receive the MBS data bursts 111, 113, and 115.

MBS includes a plurality of MBS channels, and an MBS data burst of each MBS channel is transmitted by periods. For example, if there are Channel A and Channel B, an MBS data burst of Channel A is transmitted based on a corresponding period, and an MBS data burst of Channel B is transmitted based on a corresponding period. The MBS data burst transmission period of Channel A may be the same as or different from the MBS data burst transmission period of Channel B. If MBS data burst transmission periods of a plurality of MBS channels are different from each other, the MBS MAP message 107 should be transmitted based on all the MBS data burst transmission periods. As a result, although the MBS data burst is periodically transmitted, the MBS MAP message 107 is non-periodically transmitted frequently. In addition, a physical position and size of an MBS data burst of one MBS channel does not change frequently. However, although a physical position and size of an MBS data burst of one MBS channel is the same every frame, an MBS MAP message for informing the position and size of the MBS data burst is transmitted every time.

As described above, although the MBS has a characteristic that an MBS data burst is periodically transmitted and a change of a physical position and size of the MBS data burst at a frame is rare, an MBS MAP message is transmitted together with all MBS data bursts. This causes a problem of an increase of resource consumption for the MBS MAP message transmission and a deterioration of system performance.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for reducing an overhead caused by a Multicast and Broadcast Service (MBS) MAP message in a broadband wireless communication system.

Another aspect of the present invention is to provide an apparatus and method for configuring an MBS MAP message using the periodicity of an MBS data burst in a broadband wireless communication system.

A further aspect of the present invention is to provide an apparatus and method for periodically transmitting an MBS MAP message in a broadband wireless communication system.

Yet another aspect of the present invention is to provide an apparatus and method for configuring an MBS MAP message including information on MBS data bursts having a different transmission period in a broadband wireless communication system.

The above aspects are addressed by providing an apparatus and method for communicating an MBS MAP message in a broadband wireless communication system.

In accordance with an aspect of the present invention, an operation method of a Base Station (BS) in a broadband wireless communication system is provided. The method includes periodically generating a Multicast and Broadcast Service (MBS) MAP message that includes burst allocation information on at least one MBS channel having a different transmission period, and transmitting the generated MBS MAP message in a corresponding frame based on a set period.

In accordance with another aspect of the present invention, an operation method of a Mobile Station (MS) in a broadband wireless communication system is provided. The method includes receiving an MBS MAP message based on at least one frame period from a BS, extracting burst allocation information on at least one MBS channel having a different transmission period from the received MBS MAP message, and periodically receiving an MBS data burst of each MBS channel using the extracted at least one burst allocation information, during a set period.

In accordance with a further aspect of the present invention, a BS apparatus in a broadband wireless communication system is provided. The apparatus includes a message generator and a transmitter. The message generator periodically generates an MBS MAP message that includes burst allocation information on at least one MBS channel having a different transmission period. The transmitter transmits the MBS MAP message from the message generator in a corresponding frame based on a set period.

In accordance with yet another aspect of the present invention, an MS apparatus in a broadband wireless communication system is provided. The apparatus includes a receiver, a message analyzer, and a controller. The receiver receives an MBS MAP message based on at least one frame period from a BS. The message analyzer extracts burst allocation information on at least one MBS channel having a different transmission period from the received MBS MAP message. The controller controls an operation of receiving an MBS data burst of each MBS channel using the extracted at least one burst allocation information, during a set period.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a diagram illustrating an example of a frame structure for Multicast and Broadcast Service (MBS) provision in a conventional broadband wireless communication system;

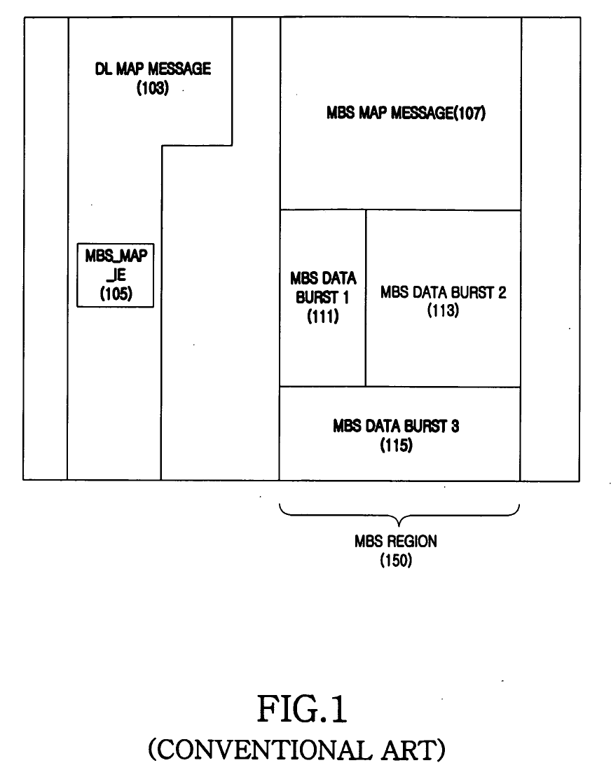

FIG. 2 is a diagram illustrating an example of MBS MAP message transmission in a broadband wireless communication system according to an exemplary embodiment of the present invention;

FIG. 3 is a flowchart illustrating an operation process of a Base Station (BS) in a broadband wireless communication system according to an exemplary embodiment of the present invention;

FIG. 4 is a flowchart illustrating an operation process of a Mobile Station (MS) in a broadband wireless communication system according to an exemplary embodiment of the present invention;

FIG. 5 is a block diagram illustrating a construction of a BS in a broadband wireless communication system according to an exemplary embodiment of the present invention; and

FIG. 6 is a block diagram illustrating a construction of an MS in a broadband wireless communication system according to an exemplary embodiment of the present invention.

Throughput the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein may be made without departing from scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A scheme for providing a broadcast service in a cellular wireless communication system is described below. More particularly, exemplary embodiments of the present invention provide a scheme for reducing an overhead caused by a Multicast and Broadcast Service (MBS) MAP message.

The broadcast service can be referred to as a MultiCast and BroadCast Service (MCBCS), a Multicast and Broadcast Service (MBS), a Multi media Broadcast and Multicast Service (MBMS), a BroadCast/MultiCast Service (BCMCS), a Digital Multimedia Broadcasting (DMB) service, a Media Forward Link Only (MediaFLO) service, etc. depending on a standard group and operator's intention.

In the following description, a name of a Network Entity or Network Element (NE) is defined depending on a corresponding function, and can be changed depending on a standard group and operator's intention. For example, a Base Station (BS) can be referred to as an Access Point (AP), a Radio Access Station (RAS), or a Node-B. Also, an Access Service Network Gateway (ASN-GW) can be called a Radio Network Controller (RNC), a Base Station Controller (BSC), or an Access Control Router (ACR).

The following description is made in the context of an Orthogonal Frequency Division Multiplexing (OFDM) broadband wireless access communication system. However, it is to be understood that this is merely for the sake of convenience and that the present invention is not limited to an OFDM-based system. Thus, it should be clearly understood that the present invention is also applicable to any other communication system using SINR estimation.

In a broadband wireless communication system according to an exemplary embodiment of the present invention, a Multicast and Broadcast Service (MBS) MAP message is periodically transmitted. In other words, the MBS MAP message is periodically transmitted irrespective of a distribution of an MBS data burst. The MBS MAP message includes transmission period information on an MBS data burst of each MBS channel, using a characteristic of periodically transmitting the MBS data burst.

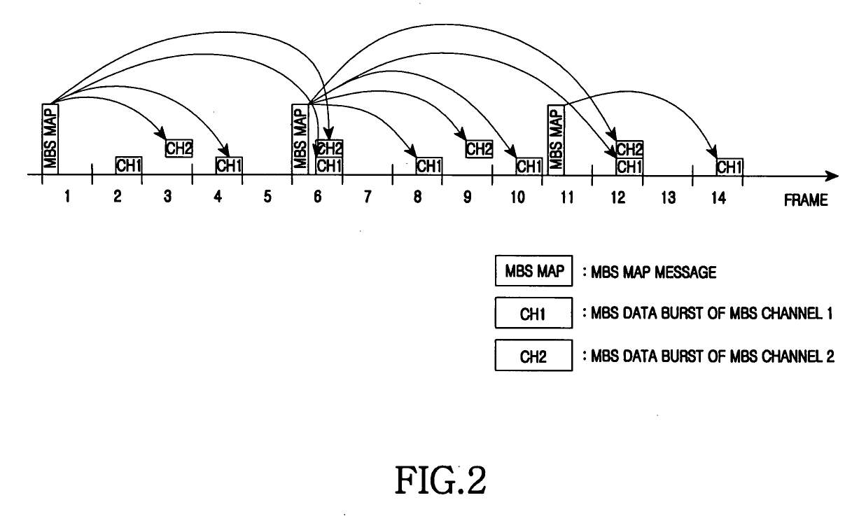

FIG. 2 illustrates an MBS MAP message and an MBS data burst transmission time of each channel when two MBS channels are provided. In FIG. 2, an arrow represents an MBS data burst indicated by each MBS MAP message.

Referring to FIG. 2, an MBS MAP message is transmitted in a 5-frame period. The assumption is that MBS Channel 1 is transmitted in a 2-frame period and MBS Channel 2's transmitted in a 3-frame period. An MBS_DATA_Information Element (MBS DATA_IE) within an MBS MAP message indicates an MBS data burst after an integer number of frames. For example, as illustrated in FIG. 2, the MBS_DATA_IE indicates an MBS data burst after two frames. An MBS MAP message transmitted in Frame 1 can include information on MBS data bursts included in Frame 3 to Frame 7. That is, each MBS MAP message can indicate MBS data bursts included in continuous frames corresponding to an MBS MAP message transmission period, and the MBS data bursts can have a different period.

The MBS MAP message transmitted in Frame 1 includes information on MBS data bursts of MBS Channel 1 transmitted in Frame 2, Frame 4, and Frame 6 and information on MBS data bursts of MBS Channel 2 transmitted in Frame 3 and Frame 6. Because the MBS data bursts of MBS Channel 1 are transmitted in a 2-frame period, the MBS MAP message can include frame offset information of Frame 1 to Frame 4 in which a first MBS data burst of MBS Channel 1 is transmitted, and transmission period information on an MBS data burst of MBS Channel 1. In addition, because the MBS data bursts of MBS Channel 2 are transmitted in a three-frame period, the MBS MAP message can include frame offset information on Frame 1 to Frame 3 in which a first MBS data burst of MBS Channel 2 is transmitted, and transmission period information on an MBS data burst of MBS Channel 2. That is, the MBS MAP message indicates all MBS data bursts of a valid duration using one MBS_DATA_IE for each of MBS channels having a different period. An example of an MBS_DATA_IE based is shown in Table 1 below.

TABLE 1

| | Size | |
|---|---|---|
| Syntax | (bits) | Notes |
| MBS_DATA_IE { | | |
| MBS_MAP_Type = 0 | 4 | MBS_DATA_IE |
| MBS Burst Frame Offset | 2 | This indicates that the burst located |
| | | by this IE will be shown after MBS |
| | | Burst Frame Offset + 2 frames. |
| No. of Multicast CID | 3 | |
| For(i=0; i<No. of Multicast | | |
| CIDs; i++) { | | |
| Multicast CID | 12 | 12 LSBs of CID for multicast |
| } | | |
| MBS DIUC | 4 | |
| OFDMA symbol offset | 8 | OFDMA symbol offset with respect |
| | | to start of the MBS portion. |
| Subchannel offset | 6 | OFDMA subchannel offset with |
| | | respect to start of the MBS portion. |
| Boosting | 3 | |
| No. OFDMA symbols | 7 | The size of MBS data. |
| No. subchannels | 6 | |
| Repetition coding | 2 | 0b00 = No repetition coding |
| indication | | 0b01 = Repetition coding of 2 used |
| | | 0b10 = Repetition coding of 4 used |
| | | 0b11 = Repetition coding of 6 used |
| 1st MBS data transmission | 8 | 8 Least Significant Bits of Frame |
| offset | | Number in which 1st MBS burst will |
| | | be transmitted. |
| Period of MBS burst | 8 | Periodicity of MBS data |
| transmission | | transmission. |
| } | | |

As shown in Table 1, the MB_DATA_IE includes ‘MBS Burst Frame Offset’ information to represent if an MBS data burst indicated by the MBS_DATA_IE is transmitted after any number of next frames, at least one ‘Multicast Connection IDentifier (CID)’ corresponding to the MBS_DATA_IE, information (i.e., ‘MBS DIUC’, ‘OFDMA symbol offset’, ‘Subchannel offset’, ‘Boosting’, ‘No. OFDMA symbols’, ‘No. subchannels’, and ‘Repetition coding indication’) required to decode a corresponding MBS data burst, ‘1st MBS data transmission offset’ information, ‘Period of MBS burst transmission’ information, etc.

In an exemplary embodiment of the present invention, the ‘1st MBS data transmission offset’ is a field to represent a frame offset from a transmission frame of an MBS MAP message to a first MBS data burst transmission frame of a corresponding channel. The ‘Period of MBS burst transmission’ is a field to represent an MBS data burst transmission period of a corresponding channel. That is, if an MBS MAP message transmission period is very long, one MBS_DATA_IE can define periodical transmission of an MBS data burst. If the transmission period is as short as transmitting an MBS data burst of a corresponding channel one time within a valid duration of one MBS MAP message, the ‘Period of MBS burst transmission’ field may be omitted.

An MBS MAP message including the MBS_DATA_IE is periodically transmitted and thus, a Mobile Station (MS) may be aware of positions of MBS data bursts to be received within a valid duration (i.e., an MBS MAP message transmission period) of the MBS MAP message through the MBS MAP message.

In an exemplary embodiment of the present invention, an MBS MAP message includes transmission time information on a next MBS MAP message together with an MBS_DATA_IE configured as described above. The transmission time information on the next MBS MAP message is expressed using a number of a frame including the next MBS MAP message. An example of the MBS MAP message including the transmission time information on the next MBS MAP message is given in Table 2 below.

TABLE 2

| | Size | |
|---|---|---|
| Syntax | (bits) | Notes |
| MBS-MAP Message format ( ) { | | |
| MAC Generic Header | 48 | 6 bytes |
| Management message type=62 | 4 | |
| Next MBS Frame Number | 16 | 16 Least Significant Bits of Frame |
| | | Number in which next MBS MAP |
| | | Message will be transmitted. |
| MBS_DIUC_Change_Count | 8 | |
| #MBS_DATA_IE | 4 | Number of included MBS_DATA_IE. |
| For(i=0;i<n;i++) { | | n = #MBS_DATA_IE |
| MBS_DATA_IE | Variable | |
| } | | |
| #MBS_DATA_Time_Diversity_IE | 4 | Number of included |
| | | MBS_DATA_Time_Diversity_IE. |
| For(i=0;i<m;i++) { | | m = #MBS_DATA_Time_Diversity_IE |
| MBS_DATA_Time_Diversity_IE | Variable | |
| } | | |
| If(!byte boundary) { | | |
| Padding nibble | 8 | |
| } | | |
| TLV encoding element | | |
| } | | |

In Table 2, the ‘Next MBS Frame Number’ field represents 16 Least Significant Bits (LSBs) of a number of a frame in which a next MBS MAP message is transmitted.

As shown in Table 2, an MBS MAP message includes transmission time information on a next MBS MAP message and thus, an MS can be aware of a transmission time of the next MBS MAP message.

In another exemplary embodiment of the present invention, if an MBS MAP message is periodically transmitted, an MS can be aware of transmission time of the MBS MAP message using a frame number. For example, a BS can modulo-operate a frame number (or part of the frame number) by a specific variable (i.e., a transmission period), and transmit an MBS MAP message in a frame having a modulo operation result value of ‘0’. Thus, the MS may be aware of a frame in which an MBS MAP message is transmitted through the frame number and the modulo operation by the transmission period.

The variable (i.e., transmission period) may be a preset value or a value forwarded to an MS from the BS. If the variable is the value forwarded to the MS from the BS, the variable may be transmitted through a broadcast message including a system parameter, and may be included in a form of Type Length Value (TLV) as shown in Table 3 below. The broadcast can be, for example, a Downlink Channel Descriptor (DCD) message, an Uplink Channel Descriptor (UCD) or Broadcast CHannel (BCH) message, etc.

TABLE 3

| Type | Length | Value |
|---|---|---|
| n | 2 | ‘x’ modulo value for MBS MAP message transmission. |

A detailed description of operations of a BS and an MS based on the aforementioned disclosure is made below.

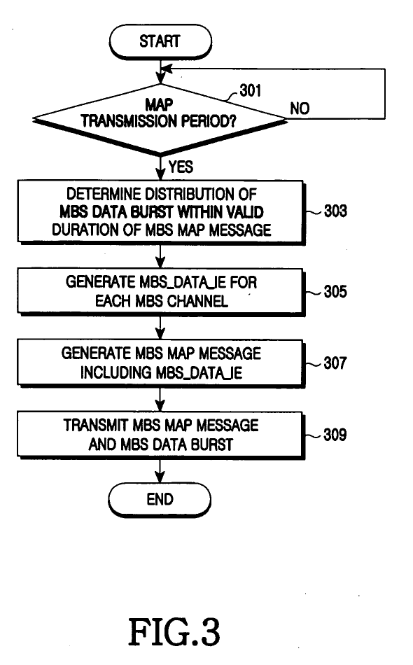

FIG. 3 is a flow diagram illustrating an operation process of a BS in a broadband wireless communication system according to an exemplary embodiment of the present invention.

Referring to FIG. 3, in step 301, the BS determines if it is an MBS MAP message transmission period. That is, the MBS MAP message is transmitted in a predefined period, and the BS determines if a present frame is a frame to transmit the MBS MAP message based on the period. For example, the BS can modulo-operate a frame number by the period value, and transmit an MBS MAP message in a frame having a modulation operation value of ‘0’.

If it is the MBS MAP message transmission period, in step 303, the BS determines a distribution of MBS data bursts within a valid duration of an MBS MAP message to be transmitted. In more detail, the BS determines how many MBS channels are provided within the valid duration of the MBS MAP message to be transmitted, and if an MBS data burst transmission period of each MBS channel is equal to any number of frames, and when a first MBS data burst of each MBS channel is transmitted. The valid duration represents a duration of continuous frames that can be indicated by one MBS MAP message. For example, the valid duration has a size corresponding to an MBS MAP message period, and can start after an integer number of frames from an MBS MAP message transmission frame.

Then, in step 305, the BS generates at least one MBS_DATA_IE for each MBS channel. That is, the BS generates an MBS_DATA_IE including transmission period information and start offset information on an MBS data burst for each MBS channel. For example, the MBS_DATA_IE may be configured as shown in Table 1 above. However, in the case of an MBS channel in which an MBS data burst is transmitted one time during the valid duration of the MBS MAP message to be transmitted, the BS can generate an MBS_DATA_IE not including the transmission period information.

After generating the MBS_DATA_IE, in step 307, the BS generates an MBS MAP message including the generated at least one MBS_DATA_IE. If a transmission time of a next MBS MAP message is informed through an MBS MAP message, the BS generates the MBS MAP message including the at least one MBS_DATA_IE and transmission time information on the next MBS MAP message. The transmission time information on the next MBS MAP message can be expressed using a frame number of a frame including a next MBS MAP message. In this case, an example of the MBS MAP message is shown in Table 2 above.

After generating the MBS MAP message, in step 309, the BS transmits the MBS MAP message and then, transmits MBS data bursts depending on the information on the MBS MAP message.

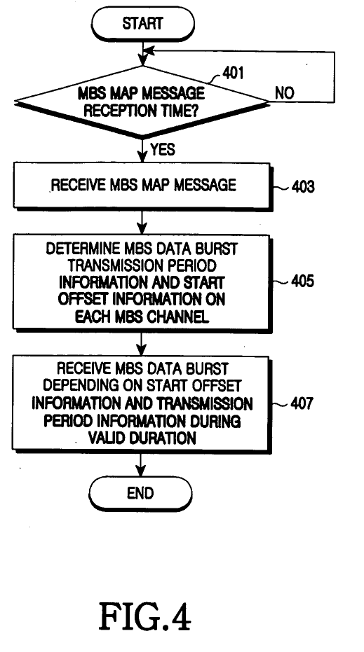

FIG. 4 is a flow diagram illustrating an operation process of a Mobile Station (MS) in a broadband wireless communication system according to an exemplary embodiment of the present invention.

Referring to FIG. 4, in step 401, the MS determines if a present frame is a frame in which an MBS MAP message is received. Here, the MBS MAP message is periodically received. MBS MAP message reception time is determined through a previous MBS MAP message or is calculated using a frame number. However, if the MS continuously performs communication, the MS can be aware of a reception time of the MBS MAP message through a DownLink (DL) MAP received in every frame.

If it is the MBS MAP message reception time, in step 403, the MS receives and analyzes an MBS MAP message. That is, the MS determines position and coding information on the MBS MAP message through a DL MAP message, and determines information included in the MBS MAP message. The MBS MAP message includes at least one MBS DATA_IE. If a transmission time of a next MBS MAP message is informed through an MBS MAP message, the MBS MAP message includes the at least one MBS DATA_IE and transmission time information on the next MBS MAP message. An example of a construction of the MBS MAP message is shown in Table 2 above.

After receiving the MBS MAP message, in step 405, the MS determines MBS data burst start offset information and transmission period information on each MBS channel through the at least one MBS_DATA_IE. That is, an MBS data burst of each MBS channel can be periodically transmitted, and one MBS_DATA_IE includes MBS data burst start offset information and transmission period information on one MBS channel. The start offset information represents a frame offset from a frame in which the MBS MAP message is received to a frame in which a first MBS data burst of a corresponding MBS channel is to be received. For example, the MBS_DATA_IE may be configured as shown in Table 1 above.

Then, in step 407, the MS receives an MBS data burst depending on the determined MBS data burst start offset information and transmission period information on each MBS channel during the valid duration of the received MBS MAP message. For example, if receiving MBS Channel 1, after the lapse of a frame corresponding to a start offset determined through an MBS_DATA_IE for MBS Channel 1, the MS receives an MBS data burst of MBS Channel 1, and continuously receives the MBS data burst of MBS Channel 1 based on a transmission period.

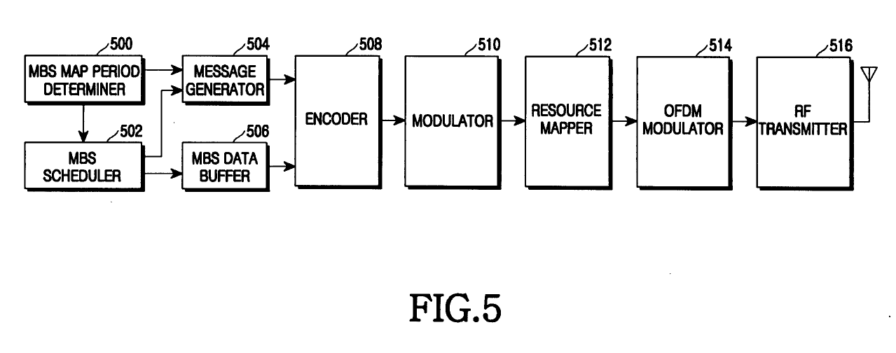

FIG. 5 is a block diagram illustrating a construction of a BS in a broadband wireless communication system according to an exemplary embodiment of the present invention.

As illustrated in FIG. 5, the BS includes an MBS MAP period determiner 500, an MBS scheduler 502, a message generator 504, an MBS data buffer 506, an encoder 508, a modulator 510, a resource mapper 512, an OFDM modulator 514, and a Radio Frequency (RF) transmitter 516.

Referring to FIG. 5, the MBS MAP period determiner 500 determines a time to transmit an MBS MAP message. For example, the MBS MAP period determiner 500 can modulo-operate a frame number in a transmission period, and determine a frame where a modulo operation value is equal to ‘0’ as an MBS MAP message transmission time. If it is the MBS MAP message transmission time, the MBS MAP period determiner 500 informs the MBS scheduler 502 and the message generator 504 that it is the MBS MAP message transmission time. That is, the MBS MAP message is transmitted in a predefined period, and the MBS MAP period determiner 500 determines if a present frame is a frame to transmit the MBS MAP message.

The MBS scheduler 502 controls MBS scheduling, and manages transmission scheduling information in an MBS data burst. If macro diversity is supported for MBS, the transmission scheduling information on the MBS data burst is shared among a plurality of BSs included in the same MBS zone, and the scheduling information (or burst allocation information) on the MBS data burst can be determined in an upper network entity. Thus, according to the case, the MBS scheduler 502 receives scheduling information from an upper node and manages the scheduling information with no scheduling for MBS data bursts.

In an exemplary embodiment of the present invention, the MBS scheduler 502 provides information for MBS MAP message generation to the message generator 504. That is, if being notified from the MBS MAP period determiner 500 that it is MBS MAP message transmission time, the MBS scheduler 502 determines a distribution of MBS data bursts within a valid duration of an MBS MAP message to be transmitted. In detail, the MBS scheduler 502 determines how many MBS channels are provided within the valid duration of the MBS MAP message to be transmitted, and if an MBS data burst transmission period of each MBS channel is equal to any number of frames, and when a first MBS data burst of each MBS channel is transmitted. The valid duration represents a duration of continuous frames that can be indicated by one MBS MAP message. For example, the valid duration has a size corresponding to an MBS MAP message period, and can start after at least one frame from an MBS MAP message transmission frame. The MBS scheduler 502 extracts MBS data burst start offset information and transmission period information on each MBS channel from the determined MBS data burst distribution information and provides the extracted MBS data burst start offset information and transmission period information on each MBS channel to the message generator 504.

The message generator 504 generates a control message (i.e., a Media Access Control (MAC) management message) to be transmitted to an MS. For example, the message generator 504 can generate a DL MAP message and an MBS MAP message that includes DL resource allocation information (i.e. MAP_IE), MBS region and MBS MAP message allocation information (i.e. MBS_MAP_IE), etc. More particularly, the message generator 504 generates the MBS MAP message using the MBS data burst start offset information and transmission period information on each MBS channel provided from the MBS scheduler 502. That is, the message generator 504 generates at least one MBS_DATA_IE that includes MBS data burst transmission period information and start offset information on each MBS channel. For example, the MBS_DATA_IE may be configured as shown in Table 1 above. However, if an MBS data burst is transmitted one time during the valid duration of the MBS MAP message to be transmitted, the MBS_DATA_IE may not include the transmission period information. At this time, the MBS_DATA_IE can be generated as many times as a number of MBS channels serviced during the valid duration. The message generator 504 generates an MBS MAP message including the at least one MBS_DATA_IE. If a transmission time of a next MBS MAP message is informed through an MBS MAP message, the message generator 504 generates the MBS MAP message including the at least one MBS_DATA_IE and transmission time information on the next MBS MAP message. The transmission time information on the next MBS MAP message can be expressed using a frame number of a frame including the next MBS MAP message. In this case, an example of the MBS MAP message is shown in Table 2 above.

The MBS data buffer 506 temporarily stores MBS data to be transmitted, and outputs stored MBS data under the control of the MBS scheduler 502.

The encoder 508 of a physical layer encodes a signaling message from the message generator 504 and a data burst from the MBS data buffer 506 according to a Modulation and Coding Scheme (MCS) level. The encoder 508 can be a Convolutional Code (CC), a Turbo Code (TC), a Convolutional Turbo Code (CTC), a Low Density Parity Check (LDPC) code, etc. The modulator 510 modulates an encoding packet from the encoder 508 according to an MCS level and generates modulated symbols. For example, the modulator 510 can use Quadrature Phase Shift Keying (QPSK), 16-Quadrature Amplitude Modulation (16QAM), 64QAM, etc.

The resource mapper 512 maps data from the modulator 510 to a predefined resource (or subcarrier). The OFDM modulator 514 OFDM-modulates the mapped data from the resource mapper 512 and generates an OFDM symbol. The OFDM modulation represents an inclusion of Inverse Fast Fourier Transform (IFFT) operation, Cyclic Prefix (CP) insertion, etc. The RF transmitter 516 converts sample data from the OFDM modulator 514 into an analog signal, converts the analog signal into an RF band signal, and transmits the RF band signal through an antenna.

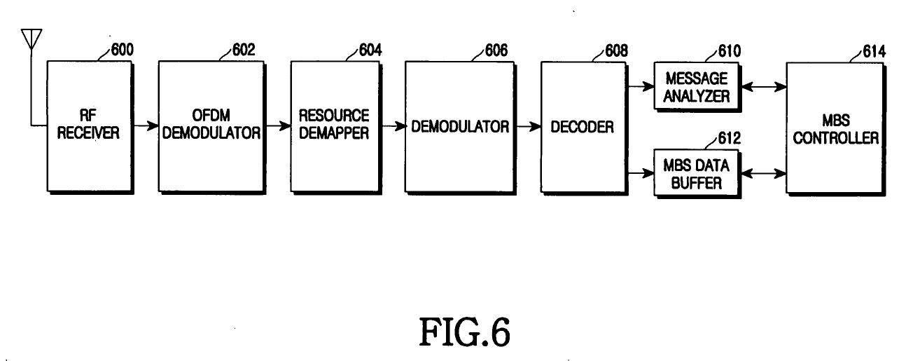

FIG. 6 is a block diagram illustrating a construction of an MS in a broadband wireless communication system according to an exemplary embodiment of the present invention.

As illustrated in FIG. 6, the MS includes an RF receiver 600, an OFDM demodulator 602, a resource demapper 604, a demodulator 606, a decoder 608, a message analyzer 610, an MBS data buffer 612, and an MBS controller 614.

Referring to FIG. 6, the RF receiver 600 converts an RF band signal received through an antenna into a baseband signal, and converts the baseband signal into digital sample data. The OFDM demodulator 602 OFDM-demodulates the sample data from the RF receiver 600 and outputs frequency domain data. The OFDM demodulation represents an inclusion of CP removal, Fast Fourier Transform (FFT) operation, etc. The resource demapper 604 extracts a burst intended for demodulation from the frequency domain data from the OFDM demodulator 603.

The demodulator 606 demodulates a burst from the resource demapper 604. The decoder 608 decodes demodulated data from the demodulator 606. If a decoded packet is a signaling message, the signaling message is provided to the message analyzer 610 and, if the decoded packet is MBS traffic, the packet is provided to the MBS data buffer 612.

The message analyzer 610 analyzes a control message received from a BS. The message analyzer 610 provides information determined from an MBS related control message to the MBS controller 614. The MBS related control message can be, for example, a DL MAP message and MBS MAP message including an MBS_MAP_IE, etc. More particularly, the message analyzer 610 determines allocation information on an MBS data burst of each channel from at least one MBS_DATA_IE included in the MBS MAP message. That is, an MBS data burst of each MBS channel is periodically transmitted, and one MBS_DATA_IE includes an MBS data burst of start offset information and transmission period information on one MBS channel. The start offset information represents a frame offset from a frame in which the MBS MAP message is received to a frame in which a first MBS data burst of a corresponding MBS channel is to be received. For example, the MBS_DATA_IE may be configured as shown in Table 1 above.

The MBS controller 614 controls an MS operation for receiving an MBS data burst. That is, the MBS controller 614 controls to receive an MBS data burst according to MBS data burst allocation information provided from the message analyzer 610. In more detail, the MBS controller 614 determines an MBS MAP message reception time. That is, the MBS MAP message is periodically received from a BS. The MBS MAP message reception time is determined through a previous MBS MAP message or can be calculated using a frame number. However, if the MS continuously performs communication, the MS may be aware of the MBS MAP message reception time through a DL MAP that is received every frame.

If it is the MBS MAP message reception time, the MBS controller 614 controls the resource demapper 604 to extract a DL MAP message and an MBS MAP message. The MBS MAP message includes at least one MBS_DATA_IE. If transmission time of a next MBS MAP message is informed through an MBS MAP message, the MBS MAP message includes the at least one MBS_DATA_IE and transmission time information on the next MBS MAP message. An example of a construction of the MBS MAP message is shown in Table 2 above. Accordingly, the MBS controller 614 controls the resource demapper 604 to extract an MBS data burst according to allocation information on an MBS data burst of each channel, i.e., according to start offset information and transmission period information during a valid duration of a received MBS MAP message. For example, if receiving MBS Channel 1, after the lapse of a frame corresponding to a start offset determined through an MBS_DATA_IE for MBS Channel 1, the MBS controller 614 controls to extract an MBS data burst of MBS Channel 1, and controls to continuously extract an MBS data burst of MBS Channel 1 based on a transmission period.

The MBS data buffer 612 temporarily stores MBS data received from a BS, and provides the MBS data to a corresponding application layer processor (not shown).

As described above, exemplary embodiments of the present invention have an advantage of reducing an overhead caused by an MBS MAP message by periodically transmitting an MBS MAP message configured using the periodicity of an MBS data burst in a broadband wireless communication system.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An operation method of a Base Station (BS) in a wireless communication system, the method comprising:
periodically generating a Multicast and Broadcast Service (MBS) MAP message that comprises burst allocation information on at least one MBS channel having a different transmission period; and
transmitting the generated MBS MAP message in a corresponding frame based on a set period.

2. The method of claim 1, wherein the MBS MAP message comprises transmission time information on a next MBS MAP message.

3. The method of claim 1, further comprising broadcasting a broadcast message, which comprises transmission period information on the MBS MAP message, to a Mobile Station (MS).

4. The method of claim 1, wherein the transmitting of the generated MBS MAP message comprises:
modulo-operating a frame number by a value corresponding to the set period; and
transmitting the MBS MAP message in a frame where the modulo operation value is equal to ‘0’.

5. The method of claim 1, wherein the burst allocation information comprises at least one of start offset information and transmission period information on an MBS data burst of a corresponding MBS channel.

6. The method of claim 1, further comprising periodically transmitting a data burst of each MBS channel during a set period, according to information on the MBS MAP message.

7. An operation method of a Mobile Station (MS) in a wireless communication system, the method comprising:
receiving a Multicast and Broadcast Service (MBS) MAP message based on at least one frame period from a Base Station (BS);
extracting burst allocation information on at least one MBS channel having a different transmission period from the received MBS MAP message; and
periodically receiving an MBS data burst of each MBS channel using the extracted at least one burst allocation information, during a set period.

8. The method of claim 7, wherein the MBS MAP message comprises transmission time information on a next MBS MAP message.

9. The method of claim 7, further comprising acquiring transmission period information on the MBS MAP message through a broadcast message received through the BS.

10. The method of claim 7, wherein the receiving of the MBS MAP message comprises:
modulo-operating a frame number by a value corresponding to a set period; and
receiving the MBS MAP message in a frame where the modulo operation value is equal to ‘0’.

11. The method of claim 7, wherein the burst allocation information comprises at least one of start offset information and transmission period information on an MBS data burst of a corresponding MBS channel.

12. A Base Station (BS) apparatus in a wireless communication system, the apparatus comprising:
a message generator for periodically generating a Multicast and Broadcast Service (MBS) MAP message that comprises burst allocation information on at least one MBS channel having a different transmission period; and
a transmitter for transmitting the MBS MAP message from the message generator in a corresponding frame based on a set period.

13. The apparatus of claim 12, wherein the MBS MAP message comprises transmission time information on a next MBS MAP message.

14. The apparatus of claim 12, wherein transmission period information on the MBS MAP message is broadcasted to a Mobile Station (MS) through a broadcast message.

15. The apparatus of claim 12, wherein the transmitter modulo-operates a frame number by a value corresponding to the set period, and transmits the MBS MAP message in a frame where the modulo operation value is equal to ‘0’.

16. The apparatus of claim 12, wherein the burst allocation information comprises at least one of start offset information and transmission period information on an MBS data burst of a corresponding MBS channel.

17. The apparatus of claim 12, wherein the transmitter periodically transmits a data burst of each MBS channel during a set period, according to information on the MBS MAP message.

18. A Mobile Station (MS) apparatus in a wireless communication system, the apparatus comprising:
a receiver for receiving a Multicast and Broadcast Service (MBS) MAP message based on at least one frame period from a Base Station (BS);
a message analyzer for extracting burst allocation information on at least one MBS channel having a different transmission period from the received MBS MAP message; and
a controller for controlling an operation of receiving an MBS data burst of each MBS channel using the extracted at least one burst allocation information, during a set period.

19. The apparatus of claim 18, wherein the MBS MAP message comprises transmission time information on a next MBS MAP message.

20. The apparatus of claim 18, wherein the message analyzer acquires transmission period information on the MBS MAP message through a broadcast message received from the BS.

21. The apparatus of claim 18, wherein the receiver modulo-operates a frame number by a value corresponding to a set period, and receives the MBS MAP message in a frame where the modulo operation value is equal to ‘0’.

22. The apparatus of claim 18, wherein the burst allocation information comprises at least one of start offset information and transmission period information on an MBS data burst of a corresponding MBS channel.
